(19) United States
(12) Patent Application Publication
(10) Pub. No.: US 2019/0325794 A1
(43) Pub. Date: Oct. 24, 2019

(54) Interactive Tradeshow Display System

(71) Applicant: Zhenwu Huang, Las Vegas, NV (US)

(72) Inventor: Zhenwu Huang, Las Vegas, NV (US)

(21) Appl. No.: 16/388,229

(22) Filed: Apr. 18, 2019

Related U.S. Application Data
(60) Provisional application No. 62/659,489, filed on Apr. 18, 2018.

(51) Int. Cl. G09G 3/00; H04N 13/388; G06F 3/14

(52) U.S. Cl. CPC G09G 3/003; H04N 13/388; G09G 2370/022; G09G 2354/00; G06F 3/1423

(57) ABSTRACT

An interactive tradeshow display system may comprise at least one base, at least one frame, at least one cover, at least one networked 3D holographic image display, and a computer means for interfacing with and controlling the said at least one networked 3D holographic image generator. The computer means may be further configured to control and interface with additional video and graphical displays and may serve as its own interactive component. Use of the interactive tradeshow display system involves a user choosing graphical images and text with the interactive tradeshow display system generating 3D holographic images with the 3D holographic image display and additional video and graphical displays.

### CROSS-REFERENCE TO RELATED APPLICATIONS

The present utility patent application claims priority benefit of the U.S. provisional application for patent Ser. No. 62/658,510 titled “Interactive Tradeshow Display System” filed on Apr. 18, 2018 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates generally to the field of tradeshow display systems. More specifically, the present invention relates to an improved and interactive tradeshow display system which incorporates multiple imaging sources.

### 2. Description of the Related Art

Trade show displays have become a popular means of promoting products, brands or services. They are often collapsible and can be easily transported and erected. Such displays are also capable of partitioning individual spaces while presenting attractive visual graphics for attendee viewing.

One of the most popular trade show display systems are retractable or collapsible banner stands. Though highly customizable, banner stands essentially consist of a frame, a base and a cover.

A typical banner stand's frame is made of easy to assemble tubing hardware that has two sets of vertical frame poles which are connected by an easy to attach or detach means such as a spring button means. The frame also includes a top rounded frame to which the vertical frame poles attach. Finally, the frame consists of a base to which the vertical frame poles also attach and provide a structural foundation for the banner stand. Assembly of today's banner stand frames require few, if any, tools to set up and is easily to disassemble and use again. Those wishing to give banner stands additional length, width and depth can arrange and connect a series of collapsible banner stands to form larger and more attractive displays.

A typical banner stand's cover may employ silkscreened banners known as tension fabric displays. Such tension fabric displays have emerged as one of the most portable and convenient display types. Most tension fabric displays consist of a knit-polyester graphic sheet that wraps around or slips over a metal frame and may be fastened at the bottom. Such display stands may be assembled and disassembled in a few easy steps. The use of tension fabric displays has become very popular in recent years as a result of their relatively inexpensive price, their ease in assembly and disassembly, their overall portability, and their limitless customizability.

With only moments to make a first and lasting impression on tradeshow passers-by, there is a demand for increasingly attractive and impression-making tradeshow display systems. Coupled with today's rapidly developing use of interactive elements, there exists a need for a tradeshow display system that integrates recently developed peripheral elements of optical holography, attachable LED displays, and optical projection systems into traditional tension fabric and silkscreened banner-style displays. Furthermore, there exists a need for a computer platform to provide users with information while simultaneously communicating with the aforementioned peripheral elements.

### SUMMARY

The object of the present invention is to provide an improved tradeshow display system that integrates elements of optical holography, wearable and sewable LED displays, projection systems, and computer technology into a traditional printed or silkscreened banner-style display to create a more eye-catching and interactive tradeshow display system. The present invention is directed towards a tradeshow display system which can be implemented as, but not limited to, a standard tradeshow display, a pop-up retail store, a presentation backdrop, or other display systems where drawing attention to a product or service is a priority.

The interactive tradeshow display system may comprise at least one base, at least one frame, at least one cover, at least one networked 3D holographic image display, and a computer means for interfacing with and controlling the said at least one networked 3D holographic image generator. The computer means may be further configured to control and interface with additional video and graphical displays and may serve as its own interactive component. Use of the interactive tradeshow display system involves a user choosing graphical images and text with the interactive tradeshow display system generating 3D holographic images with the 3D holographic image display and additional video and graphical displays.

The tradeshow display system can be readily implemented across a wide variety of forms and media including, but not limited to, rectangular tradeshow display banners, curved tradeshow display banners, angular tradeshow display banners and simple background displays. Additionally, the present invention can be readily implemented across a wide variety of mobile technologies such as, but not limited to, smartphone applications and wearable technology devices such as smart watches. Moreover, applications of the invention can be readily implemented in software, which can be stored on a readable medium (e.g., flash memory, hard disk, cloud storage, or compact disc (CD), etc.) and used with a computer system either as a stand-alone application or over a network and/or client-server system.

### BRIEF DESCRIPTION OF THE DRAWINGS

The invention directed by way of example, and not by way of limitation, in the figures of the accompanying drawings and in which like reference numerals refer to similar elements and in which:

FIG. 1 illustrates a perspective view of an exemplary tradeshow display system in accordance with an embodiment of the invention;

FIG. 2 illustrates a perspective view of the banner component of an exemplary tradeshow display system in accordance with an embodiment of the invention;

FIG. 3 illustrates a front elevation view of collapsible frame of the exemplary tradeshow display system in accordance with an embodiment of the invention;

FIG. 4 illustrates a flowchart depicting a general method for using an interactive tradeshow display system in accordance with an embodiment of the present invention.

FIG. 5 illustrates a typical computer system that, when appropriately configured or designed, may serve as a computer system for which the tradeshow display system, and the components thereof, may be embodied.

FIG. 6 illustrates a computer client-server system that, when appropriately configured or designed, can serve as an exemplary tradeshow display system, in accordance with an embodiment of the present invention.

FIG. 7 illustrates a block diagram depicting a client/server communication system which is readily implementable to the exemplary tradeshow display system.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “one variant,” “an embodiment,” “a variant,” “various embodiments,” “numerous variants,” etc., may indicate that the embodiment(s) of the invention so described may include particular features, structures, or characteristics. However, not every embodiment or variant necessarily includes the particular features, structures, or characteristics. Further, repeated use of the phrase “in one embodiment,” or “in an exemplary embodiment,” or “a variant,” or “another variant,” do not necessarily refer to the same embodiment although they may. A description of an embodiment with several components in communication with each other does not imply that all such components are required. On the contrary, a variety of optional components are described to illustrate the wide variety of possible embodiments and/or variants of the present invention.

A “computer” may refer to one or more apparatus and/or one or more systems that are capable of accepting a structured input, processing the structured input according to prescribed rules, and producing results of the processing as output. Examples of a computer may include: a personal computer (PC); a stationary and/or portable computer; a computer having a single processor, a computer having multiple processors, or a computer having multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer; a personal digital assistant (PDA); a portable telephone; a portable smartphone; wearable devices such as smartwatches; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

The term “processor” may refer to any device or portion of a device that processes electronic data from registers and/or memory to transform that electronic data into other electronic data that may be stored in registers and/or memory. A “computing platform” may comprise one or more processors.

A “microcontroller” generally refers a small computer on a single integrated circuit. A microcontroller contains one or more central processing units (processor cores) along with memory and programmable input/output peripherals. A typical microcontroller includes a processor, memory and input/output (I/O) peripherals on a single chip.

An “algorithm” is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

It will be readily understood by persons skilled in the art that the various methods and algorithms described herein may be implemented by appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

“Software” may refer to prescribed rules and/or instructions used to operate a computer. Examples of software may include: code segments in one or more computer-readable languages; graphical and or/textual instructions; applets; pre-compiled code; interpreted code; compiled code; and computer programs. An operating system or “OS” is software that manages computer hardware and software resources and provides common services for computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™, SQL, Python, or other compilers, assemblers, interpreters or other computer languages or platforms.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “non-transitory computer readable medium” includes, but is not limited to, a hard drive, compact disc, flash memory, volatile memory, random access memory, magnetic memory, optical memory, semiconductor-based memory, phase change memory, optical memory, periodically refreshed memory, and the like; however, the non-transitory computer readable medium does not include a pure transitory signal per se.

A “computer system” may refer to a system having one or more computers, where each computer may include a computer-readable medium employing software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a plurality of computers and associated devices that may be connected by communication channels to facilitate communication and resource sharing. A network may involve permanent connections such as cables or temporary connections such as those made through telephone, cable, wireless or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include, but are not limited to, an internet, such as the Internet or World Wide Web; an intranet; a personal area network (PAN); near field communication (NFC); a local area network (LAN); a wide area network (WAN); a virtual private network (VPN); internet of things (IoT); Blockchain; and a combination of networks, such as an internet and an intranet.

Exemplary networks may operate with any of a number of protocols such as, but not limited to, Transmission Control Protocol (TCP), Internet protocol (IP), Internet Address Protocol (IP Address), asynchronous transfer mode (ATM), Near Field Communication digital protocol, and/or synchronous optical network (SONET), user datagram protocol (UDP), IEEE 802.x, etc.

“Video” may refer to motion pictures represented in analog and/or digital form. Examples of video may include television, movies, image sequences from a camera or other observer, and computer-generated image sequences. Video may be obtained from, for example, a live feed, a storage device, an IEEE 1394-based interface, a video digitizer, a computer graphics engine, or a network connection.

A “light-emitting diode” (LED) is a two-lead semiconductor light source. which uses semiconductors and electroluminescence to create light create light by electroluminescence in a semiconductor material. Electroluminescence is the phenomenon of a material emitting light when electric current or an electric field is passed through it. A variant of the LED, an “organic light emitting diode” OLED uses organic (carbon) molecules in its semiconductor material that emits light when current or an electric field passes through it.

The term “persistence of vision display” or “POV display” has been used for certain LED display devices that compose images by displaying one spatial portion at a time in rapid succession (for example, one column of pixels every few milliseconds. A two-dimensional POV display is often accomplished by means of rapidly moving a single row of LEDs along a linear or circular path. The effect is that the image is perceived as a whole by the viewer as long as the entire path is completed during the visual persistence time of the human eye. A further effect is often to give the illusion of the image floating in mid-air. A three-dimensional POV display is often constructed using a 2D grid of LEDs which is swept or rotated through a volume. POV display devices can be used in combination with long camera exposures to produce light writing.

Embodiments of the interactive tradeshow display system may include more than one apparatus for performing the operations disclosed herein. An apparatus may be specially constructed for the desired purposes, or it may comprise one or more general-purpose devices selectively activated or reconfigured by a program stored in the device. Moreover, embodiments of the tradeshow display system may employ differing shapes and sizes to achieve a customized look.

Embodiments of the interactive tradeshow display system may also be implemented in, or in a combination of, hardware, firmware, and software. Such embodiments may be implemented as instructions stored on a machine-readable medium, which may be read and executed by a computing platform to perform the operations described herein.

Unless specifically stated otherwise, and as may be apparent from the following description and claims, it should be understood that throughout this application's specification, descriptions utilizing terms such as “processing,” “computing,” “calculating,” “determining,” or the like, refer to the actions and/or processes of a computer, computing system, or any similar electronic computing device which manipulates and/or transforms data represented as physical quantities within the computing system's registers and/or memories into other data similarly represented as physical quantities within the computing system's memories, registers or other such information storage, transmission or display devices.

Aspects of the exemplary interactive tradeshow display system will be described below with reference to flowchart illustrations and/or block diagrams of methods, steps, apparatus (systems) and computer program products according to embodiments of the invention. Persons skilled in the art will understand that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the exemplary tradeshow display system. It will become readily apparent to persons skilled in the art that each block in the flowchart or block diagrams may represent a module, segment, or portion of code, which comprises one or more executable instructions for implementing the specified logical function(s). It will also be readily apparent to persons skilled in the art that in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any practical order.

It will also be understood by persons skilled in the art that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram blocks.

When a single device or article is described herein, it will be readily apparent to persons having skill in the art that more than one device or article or/machine (whether or not they cooperate) may be used in place of a single device or article or machine. Similarly, where more than one device or article or machine is described herein (whether or not they cooperate), it will be readily apparent that a single device/article may be used in place of the more than one device or article. Likewise, the functionality and/or the features of a device or article or machine may be alternatively embodied by one or more other devices or articles or machines which are not explicitly described as having such functionality and/or features. Thus, other embodiments of the present invention need not include a specific device in and of itself.

As is well known to those skilled in the art, many careful considerations and compromises typically must be made when designing the optimal manufacture or commercial implementation of such a tradeshow display system. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

Systems will be described and provided with means and methods for providing and implementing an interactive tradeshow display system. The exemplary interactive tradeshow display system will now be described in detail with reference to embodiments thereof as illustrated in the accompanying drawings.

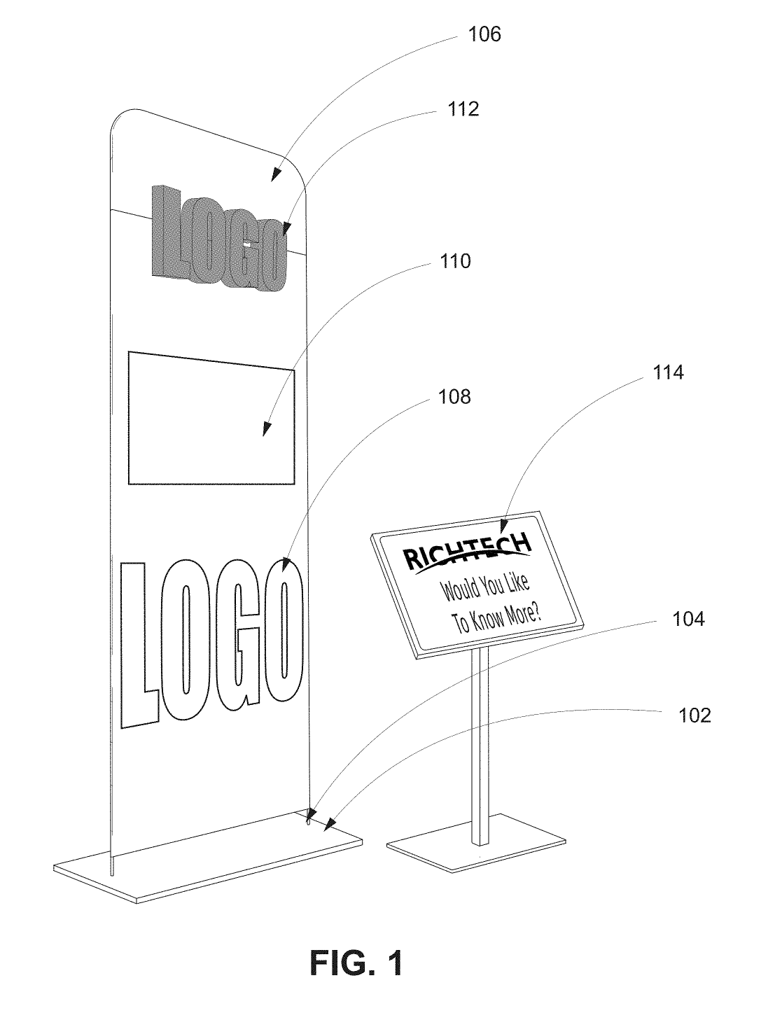

FIG. 1 illustrates a perspective view of an interactive tradeshow display system employed by an embodiment of the present invention. The interactive tradeshow display system is comprised of a banner stand component which includes a base 102, a frame 104 and a cover 106. The cover 106 may contain one or more graphics 108. Persons having skill in the art will understand that the cover material used is a polyester tension fabric which may be stretched over the frame. Graphics may be applied in numerous places and may take on the shape or form of any desired image, and may be applied in numerous means including, but not limited to, printing, silk screening, and applied decals. Persons skilled in the art will understand that a power source is also provided and can include a battery or preferably, an alternating or direct current means such as, but not limited to, a 110-volt power source commonly provided to tradeshow participants or lithium-ion batteries for peripheral components such as video displays or holographic image generators.

The tradeshow display system may also contain at least one electronic video display 110 which may be attached to the cover 106. In the preferred embodiment of the invention, the video display may take on the form of a networked LED banner which may be sewn into or attached to the tension fabric by a hook and eye fastening system commonly referred to by the trade name, Velcro®. Such LED displays are known and appreciated in the art and may vary from simple 8×32 LED panels to 12×64 LED panels to even more complex RGB and OLED systems currently being researched and developed. The electronic video display system may employ a computer or microcontroller means and be networked interfaced with a computer component 114. The addition of such a display system is designed to provide a vast improvement over the prior art in the sense that the present invention provides a more eye-catching and attractive display.

Also included in the exemplary tradeshow display system is a 3D holographic image generator 112 capable of producing bright, three-dimensional appearing images capable of being seen from a distance. In the preferred embodiment of the invention, the holographic image generator is a persistence of vision display consisting of a fan with a plurality of networked LED lights which employs the persistence of vision effect to display an image such that human eyes imagine the said image as an independent, floating image. Persistence of vision is an optical illusion that occurs when visual perception of an object does not cease for some time after the rays of light proceeding from it have ceased to enter the eye. The effect is based on the inertia of the human eye which has a response time of around 1/24 to 1/16 second. The LED(s) or LED array employed by the holographic image generator can be controlled by microprocessor means to change faster than the 1/24 to 1/16 second response time so that even though an object moves faster than the human eye response time, the last image stays in the human eye and brain for a period of time. The holographic image generator 112 is governed by a microcontroller means and may be interfaced with a computer component 114. Persons having skill in the art will appreciate that such technology is capable of being implemented in numerous means. The holographic image generator may support files such as, but not limited to, jpg, gif, mp4, avi, rmvb, mpeg, jpg, gif, mp4, avi, rmvb, and mpeg.

Fundamentally integrated into the tradeshow display system is a computer component 114. The computer component 114 may be networked to a number of peripheral output devices such as, but not limited to, an electronic video display 110 or a holographic image generator 112. In addition, the computer component may be networked to a screen projector. Persons skilled in the art will readily appreciate that the computer component could take on the form of a smartphone, a tablet, personal computer, laptop computer, or a personal computer with a touch-screen display. The computer component 114 may also be used as a part of the interactive tradeshow display system to not only control the networked peripheral output devices, but to serve as part of the display system itself.

In the preferred embodiment of the invention, the computer component takes on the form of an adjustable flat-screen touch table. Persons skilled in the art will readily appreciate that such a table could include, but is not limited to, a 42″ touch screen that includes high-definition resolution producing clear text and images, bold colors, and superior interaction. Such a touch table would be suitable for up to ten users at a time and could be built to accommodate multiple chairs or wheelchairs. Persons having skill in the art will readily appreciate that such a computer component may be networkable to the electronic video display 110, the holographic image generator 112 and other peripheral devices such as, but not limited to, a screen projector, speakers or lighting systems.

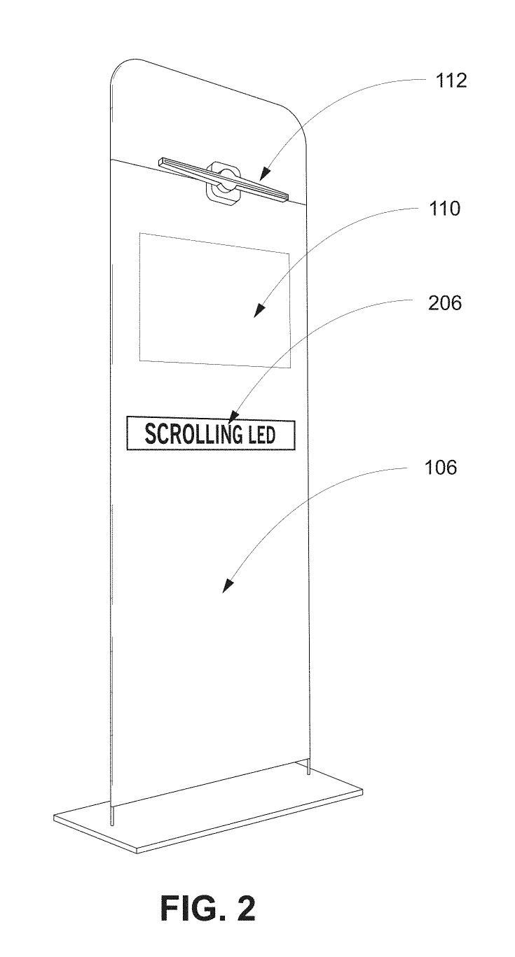

FIG. 2 illustrates a perspective view of the banner stand component of a tradeshow display system employed by an embodiment of the present invention. The banner component integrates the latest in holographic, screen projection, and fabric light emitting diode (LED) technologies to create a more attractive display. Pictured is the holographic image generator 112 when not in motion. The preferred embodiment of the invention employs a two-blade fan system known and appreciated in the art, but systems incorporating multiple blades and multiple fans may be used to create increasingly vivid and more intense holographic effects. In such image generation systems, a microcontroller is connected to a plurality of rotating light emitting elements where during a complete revolution of the rotating object the microcontroller flashes the light emitting elements according to an image map stored in memory, so that when viewed by humans a steady coherent image is displayed with the refresh rate of the image equal to the rotational frequency of the object. This image may be a simple image file or a more complex animation.

In addition, an electronic video display 110 is also shown. The electronic video display may take on the form of an LED banner which may be sewn into or attached to the tension fabric by a hook and eye fastening system commonly referred to by the trade name, Velcro®. Such LED displays are known and appreciated in the art and may vary from simple 8×32 LED panels to 12×64 LED panels to even more complex (OLED) systems currently being researched and developed. The electronic video display system may employ a microcontroller means and be networked and/or interfaced with a computer component 114. In other embodiments of the invention, a scrolling LED display 206 may also be attached to the tension fabric. Like the networked electronic video display 110, the scrolling LED display may employ a microcontroller means and be networked and/or interfaced with a computer component 114. In alternative embodiments of the invention, a projection screen may be used in conjunction with a video projector networked with the computer component 114.

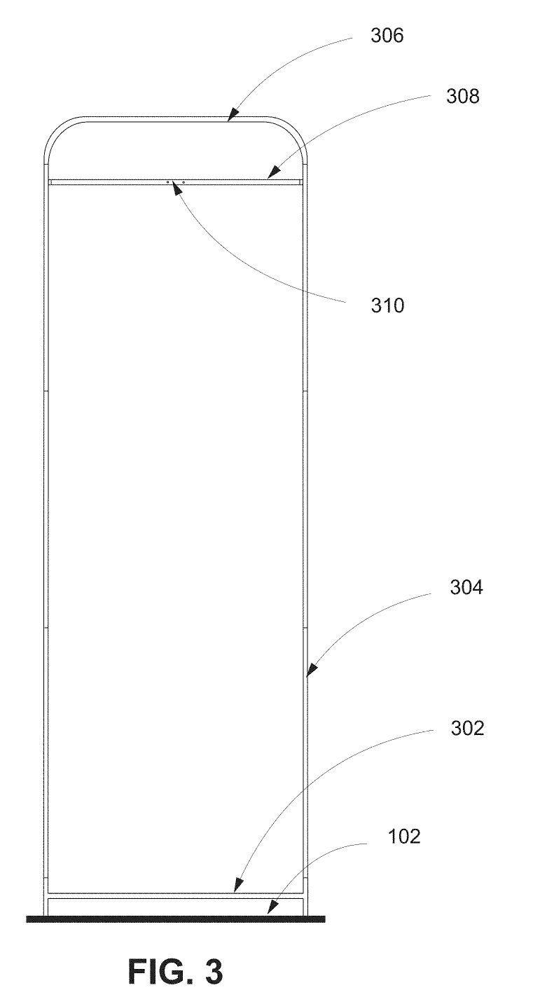

FIG. 3 illustrates a front view of the collapsible frame of the banner component of a tradeshow display system employed by an embodiment of the present invention. The frame consists of a base 102, a tubular lower cross-member and tubular mounting bracket 302, tubular vertical members 304 which may be fitted to the base and held in place with a push button spring snap clip attaching mechanism. The vertical members connect together by the push button spring mechanism or may connect to a top member 306. One or more cross members 308 may be fitted to the vertical members to provide additional frame rigidity. Additionally, mounting points 310 may be configured to the cross members 308. The mounting points 310 may be configured in numerous ways such as, but not limited to, screw holes, peg holes, and various other attachment points and methods so as to provide a secure attachment point for the networked 3D holographic image generator as well as the networked electronic video displays. Persons having skill in the art will understand that the frame components may be made from a metal such as aluminum or stainless steel or it may be made from numerous plastics such as, but not limited to, Polyvinyl Chloride (PVC). It will also become readily apparent to persons having skill in the art that the base and frame components may be configured to varying sizes and shapes so as to create a customizable framing system including, but not limited to, rectangular frames, square frames, curved frames, concave frames and angled frames.

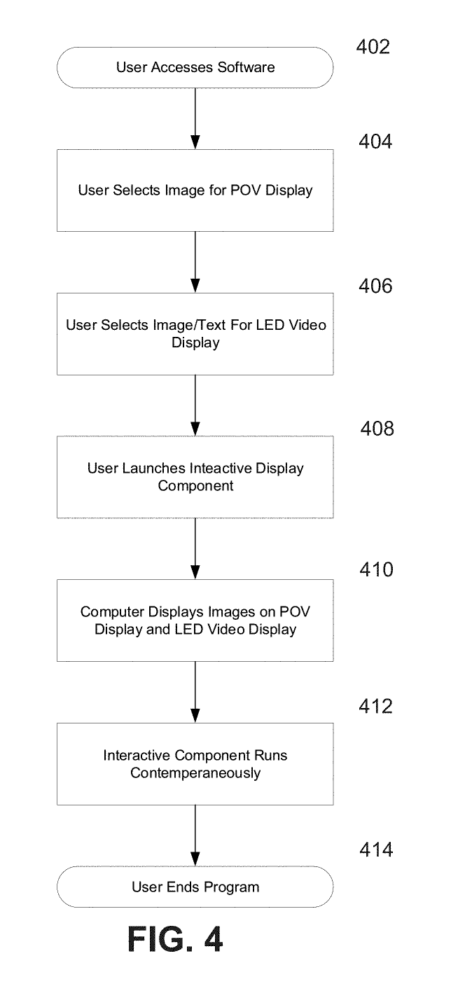

FIG. 4 illustrates a flowchart depicting a general method for using an interactive tradeshow display system in accordance with an embodiment of the present invention. In the present embodiment, a user may access interactive software in a step 402. In some embodiments, users may access software through use of any suitable user device 114. In many embodiments, user device 114 may establish a connection to each component through a wired or wireless connection. In some embodiments, users may register and/or login to software. In some alternate embodiments, users may be required to pay per use or sign up for a subscription for multiple uses. In some embodiments, each use may comprise any number of optional components, including, without limitation, a question category, text fields, spreadsheets, documents, photos, videos, audio samples, drawings, and/or website uniform resource locators (URLs). In a non-limiting example, a user selects an image for the 3D hologram or persistence of vision fan display from a memory device or the internet 404. The user then selects an image from a memory device or the internet or enters text from a typical I/O device such as, but not limited to, a keyboard 406. The user then may launch the interactive display component 408 which may be custom programmed to provide viewers/customers of the interactive tradeshow display system a more interactive experience including, but not limited to, a virtual tour of the goods and/or services being marketed with the interactive tradeshow display system. After the user enters the images and/or text, the computer or user device 114 will communicate the image and/or text data to at least one of the 3D hologram displays and/or at least one of the LED video displays 410. The interactive user device may run contemporaneously with the other networked devices 412. When finished, the user may simply end the program thus shutting the interactive tradeshow display system components down 414.

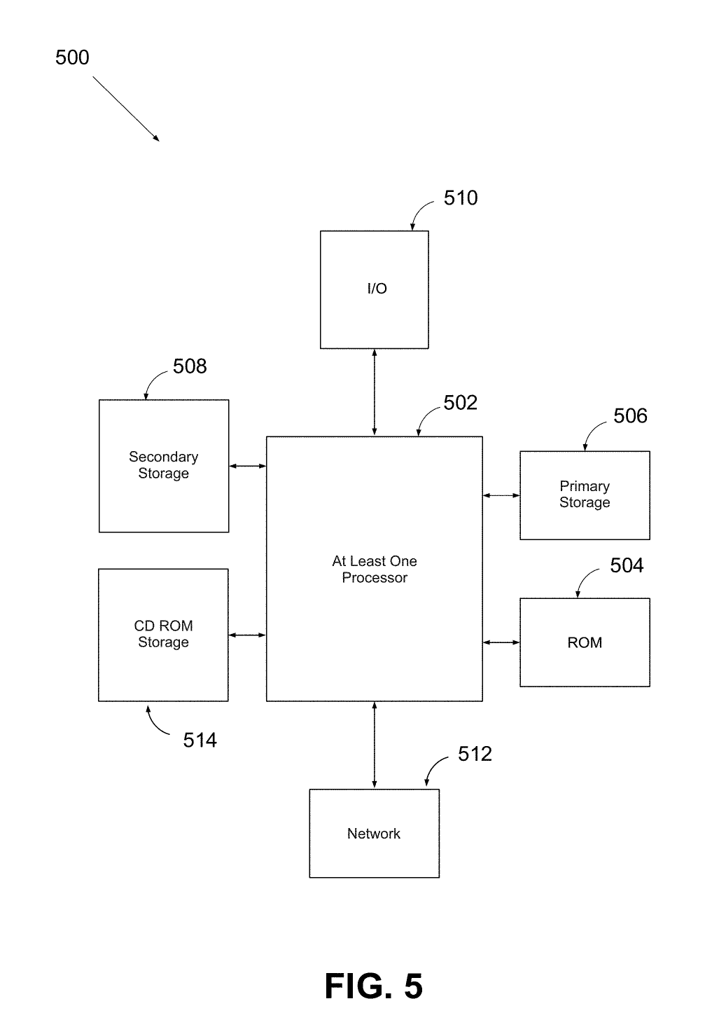

FIG. 5 illustrates a typical computer system that, when appropriately configured or designed, may serve as a computer system for which the tradeshow display system, and the components thereof, may be embodied.

The computer system 500 includes a quantity of processors 502 (also referred to as central processing units, or CPUs) that may be coupled to storage devices including a primary storage 506 (typically a random-access memory, or RAM), a primary storage 504 (typically a read-only memory, or ROM). CPU 502 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 504 acts to transfer data and instructions uni-directionally to the CPU and primary storage 506 typically may be used to transfer data and instructions in a bi-directional manner. The primary storage devices discussed previously may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and typically may be used as a secondary storage medium such as a hard disk. It will be appreciated that the information retained within mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as such as video monitors, LED displays, OLED displays, holographic displays, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection shown generally as a network 512, which may be implemented as a hardwired or wireless communications link using suitable conventional technologies. With such a connection, the CPU might receive information from the network, or might output information to the network in the course of performing the method steps described in the teachings of the present invention.

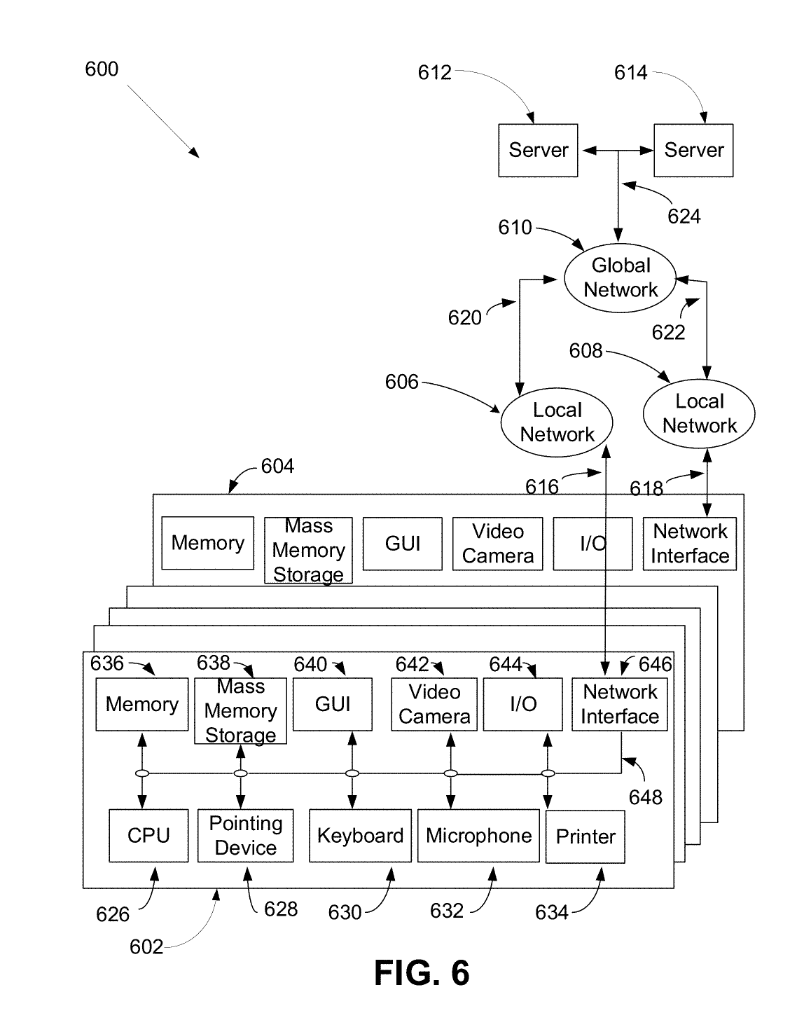

FIG. 6 illustrates a computer client-server system that, when appropriately configured or designed, can serve as an exemplary tradeshow display system, in accordance with an embodiment of the present invention. In the present invention, a communication system 600 includes a multiplicity of clients with a sampling of clients denoted as a client 602 and a client 604, a multiplicity of local networks with a sampling of networks denoted as a local network 606 and a local network 608, a global network 610 and a multiplicity of servers with a sampling of servers denoted as a server 612 and a server 614.

Client 602 may communicate bi-directionally with local network 606 via a communication channel 616. Client 604 may communicate bi-directionally with local network 608 via a communication channel 618. Local network 606 may communicate bi-directionally with global network 610 via a communication channel 620. Local network 608 may communicate bi-directionally with global network 610 via a communication channel 622. Global network 610 may communicate bi-directionally with server 612 and server 614 via a communication channel 624. Server 612 and server 614 may communicate bi-directionally with each other via communication channel 624. Furthermore, clients 602, 604, local networks 606, 608, global network 610 and servers 612, 614 may each communicate bi-directionally with each other.

In one embodiment, global network 610 may operate as the Internet or the World Wide Web (WWW). It will be understood by those skilled in the art, though, that communication system 600 may take many different forms. Non-limiting examples of forms for communication system 600 include local area networks (LANs), wide area networks (WANs), wired telephone networks, wireless networks, or any other network supporting data communication between respective entities.

Clients 602 and 604 may take many different forms. Non-limiting examples of clients 602 and 604 include personal computers, tablet computers, personal digital assistants (PDAs), cellular phones and smartphones.

Client 602 includes a CPU 626, a pointing device 628, a keyboard 630, a microphone 632, a printer 634, a memory 636, a mass memory storage 638, a GUI 640, a video camera 642, an input/output interface 644 and a network interface 646. CPU 626, pointing device 628, keyboard 630, microphone 632, printer 634, memory 636, mass memory storage 638, GUI 640, video camera 642, input/output interface 644 and network interface 646 may communicate in a unidirectional manner or a bi-directional manner with each other via a communication channel 648. Communication channel 648 may be configured as a single communication channel or a multiplicity of communication channels.

CPU 626 may be comprised of a single processor or multiple processors. CPU 626 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 636 is used typically to transfer data and instructions to CPU 626 in a bi-directional manner. Memory 636, as discussed previously, may include any suitable computer-readable media, intended for data storage, such as those described above excluding any wired or wireless transmissions unless specifically noted. Mass memory storage 638 may also be coupled bi-directionally to CPU 626 and provides additional data storage capacity and may include any of the computer-readable media described above. Mass memory storage 638 may be used to store programs, data and the like and is typically a secondary storage medium such as a hard disk. It will be appreciated that the information retained within mass memory storage 638, may, in appropriate cases, be incorporated in standard fashion as part of memory 636 as virtual memory.

CPU 626 may be coupled to GUI 640. GUI 640 enables a user to view the operation of computer operating system and software. CPU 626 may be coupled to pointing device 628. Non-limiting examples of pointing device 628 include computer mouse, trackball and touchpad. Pointing device 628 enables a user with the capability to maneuver a computer cursor about the viewing area of GUI 640 and select areas or features in the viewing area of GUI 640. CPU 626 may be coupled to keyboard 630. Keyboard 630 enables a user with the capability to input alphanumeric textual information to CPU 626. CPU 626 may be coupled to microphone 632. Microphone 632 enables audio produced by a user to be recorded, processed and communicated by CPU 626. CPU 626 may be connected to printer 634. Printer 634 enables a user with the capability to print information to a sheet of paper. CPU 626 may be connected to video camera 642. Video camera 642 enables video produced or captured by user to be recorded, processed and communicated by CPU 626.

CPU 626 may also be coupled to input/output interface 644 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers. In the present invention, the input/output interface may be connected to the 3D hologram display and the LED

Finally, CPU 626 optionally may be coupled to network interface 646 which enables communication with an external device such as a database or a computer or telecommunications or internet network using an external connection shown generally as communication channel 616, which may be implemented as a hardwired or wireless communications link using suitable conventional technologies. With such a connection, CPU 626 might receive information from the network, or might output information to a network in the course of performing the method steps described in the teachings of the present invention.

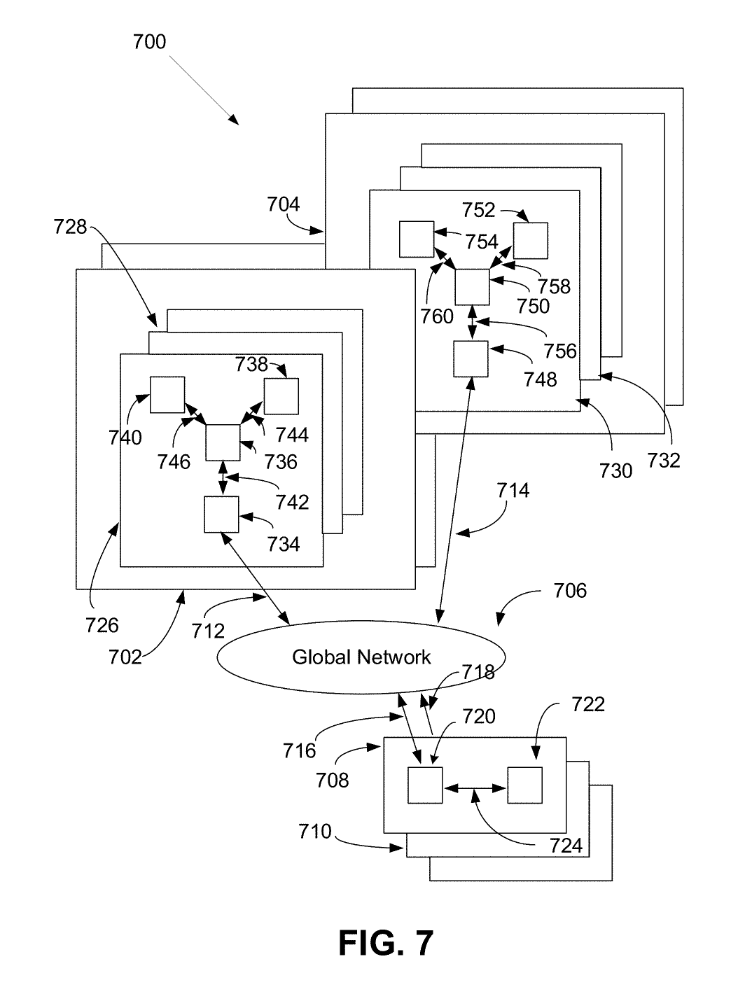

FIG. 7 illustrates a block diagram depicting a client/server communication system which is readily implementable to the exemplary tradeshow display system. Such a communication system 700 includes a multiplicity of networked regions with a sampling of regions denoted as a network region 702 and a network region 704, a global network 706 and a multiplicity of servers with a sampling of servers denoted as a server device 708 and a server device 710.

Network region 702 and network region 704 may operate to represent a network contained within a geographical area or region. Non-limiting examples of representations for the geographical areas for the networked regions may include general locations, neighborhoods, postal zip codes, telephone area codes, states, counties, cities and countries. Elements within network region 702 and 704 may operate to communicate with external elements within other networked regions or within elements contained within the same network region.

In some implementations, the global network 706 may operate as the internet or World Wide Web. It will be understood by those skilled in the art that the communication system 700 may take many different forms. Non-limiting examples of forms for communication system 700 include personal area networks (PANs), local area networks (LANs), wide area networks (WANs), wired telephone networks, cellular telephone networks, internet of things (IoT), or any other network supporting data communication between respective entities via hardwired or wireless communication networks. A global network 706 may operate to transfer information between the various networked elements.

Server device 708 and server device 710 may operate to execute software instructions, store information, support database operations and communicate with other networked elements of the tradeshow display system. Non-limiting examples of software and scripting languages which may be executed on server device 708 and server device 710 include C, C++, C#, Python, PHP, SQL, JavaScript, and Swift.

Network region 702 may operate to communicate bi-directionally with global network 706 via a communication channel 712. Network region 704 may operate to communicate bi-directionally with global network 706 via a communication channel 714. Server device 708 may operate to communicate bi-directionally with global network 706 via a communication channel 716. Server device 710 may operate to communicate bi-directionally with global network 706 via a communication channel 718. Network region 702 and 704, global network 706 and server devices 708 and 710 may operate to communicate bi-directionally and also communicate bi-directionally with other networked device located within communication system 710.

Server device 708 includes a networking device 720 and a server 722. Networking device 720 may operate to communicate bi-directionally with global network 706 via communication channel 716 and with server 722 via a communication channel 724. Server 722 may operate to execute software instructions and store information.

Network region 702 includes a multiplicity of clients with a sampling denoted as a client 726 and a client 728. Client 726 includes a networking device 734, a processor 736, a GUI 738 and an interface device 740. Non-limiting examples of devices for GUI 738 include monitors, televisions, holographic display systems, cellular telephones, smartphones and PDAs (Personal Digital Assistants). Non-limiting examples of interface device 740 include pointing device, mouse, touchscreen display, trackball, scanner and printer. Networking device 734 may communicate bi-directionally with global network 706 via communication channel 712 and with processor 736 via a communication channel 742. GUI 738 may receive information from processor 736 via a communication channel 744 for presentation to a user for viewing. Interface device 740 may operate to send control information to processor 736 and to receive information from processor 736 via a communication channel 746. Network region 704 includes a multiplicity of clients with a sampling denoted as a client 730 and a client 732. Client 730 includes a networking device 748, a processor 750, a GUI 752 and an interface device 754. Non-limiting examples of devices for GUI 738 include monitors, televisions, holographic display systems, tablets, cellular telephones, smartphones and PDAs (Personal Digital Assistants). Non-limiting examples of interface device 740 include pointing devices, mice, trackballs, scanners and printers. Networking device 748 may communicate bi-directionally with global network 706 via communication channel 714 and with processor 750 via a communication channel 756. GUI 752 may receive information from processor 750 via a communication channel 758 for presentation to a user for viewing. Interface device 754 may operate to send control information to processor 750 and to receive information from processor 750 via a communication channel 760.

For example, consider the case where a user interfacing with client 726 may want to execute a networked application. A user may enter the IP (Internet Protocol) and or MAC (Media Access Control) address for the networked application using interface device 740, or software or firmware instructions may accomplish this task. The IP and/or MAC address information may be communicated to processor 736 via communication channel 746. Processor 736 may then communicate the IP and/or MAC address information to networking device 734 via communication channel 742. Networking device 734 may then communicate the IP and/or MAC address information to global network 706 via communication channel 712. Global network 706 may then communicate the IP and/or MAC address information to networking device 720 of server device 708 via communication channel 716. Networking device 720 may then communicate the IP and/or MAC address information to server 722 via communication channel 724. Server 722 may receive the IP and/or MAC address information and after processing the IP and/or MAC address information may communicate return information to networking device 720 via communication channel 724. Networking device 720 may communicate the return information to global network 706 via communication channel 716. Global network 706 may communicate the return information to networking device 734 via communication channel 712. Networking device 734 may communicate the return information to processor 736 via communication channel 742. Processor 736 may communicate the return information to GUI 738 via communication channel 744. User may then view the return information on GUI 738. Persons having skill in the art will understand that this process is largely accomplished by myriad software applications.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the interactive tradeshow display system, other equivalent or alternative methods of implementing the tradeshow display system according to the present invention will be apparent to those skilled in the art. Various aspects of the tradeshow display system have been described above by way of illustration, and the specific embodiments disclosed are not intended to limit the invention to the particular forms disclosed. The particular implementation of the tradeshow display system may vary depending upon the particular context or application. By way of example, and not limitation, the tradeshow display system described in the foregoing was principally directed to tradeshow display banners. However, similar techniques may instead be applied to other advertising and or sales systems which implementations of the present invention are contemplated as within the scope of the present invention. Additionally, differing combinations and arrangements of display technologies may be implemented to achieve a more desirable appearance. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Although specific features of the tradeshow display system are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively, and are not limited to any physical interconnection. Claim elements and steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. An interactive tradeshow display system comprising:
at least one base;
at least one frame;
at least one cover;
at least one networked 3D holographic image generator; and
a computer means for a user to provide images and text to said computer means and the said computer means being configured to display the said images and text on the said 3D holographic image generator.

2. The interactive tradeshow display system of claim 1 wherein the at least one base is weighted so as to support the at least one frame.

3. The interactive tradeshow display system of claim 1 wherein the at least one frame consists of at least two tubular vertical members, at least one top member, one or more cross members and mounting points for components.

4. The interactive tradeshow display system of claim 1 wherein the at least one cover is a polyester tension fabric where graphics may be applied in numerous places on the said cover by printing, silk screening and applied decals which, when said graphics are applied, may be stretched over the frame.

5. The interactive tradeshow display system of claim 1 wherein the at least one networked 3D holographic image generator is a persistence of vision display consisting of a fan with a plurality of networked LED lights which employs the persistence of vision effect to display an image such that human eyes imagine the said image as an independent, floating image.

6. The interactive tradeshow display system of claim 1 wherein the at least one networked 3D holographic image generator may be mounted to the at least one frame.

7. An interactive tradeshow display system comprising:
at least one base;
at least one frame;
at least one cover;
at least one networked 3D holographic image generator;
at least one networked electronic video display;
at least one computer means being configured for a user to provide images and text and the said computer being further configured to display the said images and text on the said at least one 3D holographic display, and the said at least one networked electronic video display.

8. The interactive tradeshow display system of claim 7 wherein the at least one base is weighted so as to support at least one frame.

9. The interactive tradeshow display system of claim 7 wherein the at least one frame consists of at least two tubular vertical members, at least one top member, one or more cross members and mounting points for components.

10. The interactive tradeshow display system of claim 7 wherein the at least one cover is a polyester tension fabric where graphics may be applied in numerous places on the said cover by printing, silk screening and applied decals which, when said graphics are applied, may be stretched over the frame.

11. The interactive tradeshow display system of claim 7 wherein the at least one networked 3D holographic image generator is a persistence of vision display consisting of a fan with a plurality of networked LED lights which employs the persistence of vision effect to display an image such that human eyes imagine the said image as an independent, floating image.

12. The interactive tradeshow display system of claim 7 wherein the at least one networked 3D holographic image generator may be mounted to the at least one frame.

13. The interactive tradeshow display system of claim 14 wherein the at least one networked electronic video display is a networked sewable or wearable LED display which may be attached to the cover component of the said interactive tradeshow display system.

14. An interactive tradeshow display system comprising:
at least one base;
at least one frame;
at least one cover;
at least one networked 3D holographic image generator;
at least one networked electronic video display; and
at least one client and server means being configured for a client to provide images and text and to convey to the server system which is further configured to process the said images and text and to display the said images and text on a 3D holographic display, a video display and an LED image display and to convey to said server the said user provided images and text.

15. The interactive tradeshow display system of claim 14 wherein the at least one base is weighted so as to support at least one frame.

16. The interactive tradeshow display system of claim 14 wherein the at least one frame consists of at least two tubular vertical members, at least one top member, one or more cross members and mounting points for components.

17. The interactive tradeshow display system of claim 14 wherein the at least one cover is a polyester tension fabric where graphics may be applied in numerous places on the said cover by printing, silk screening and applied decals which, when said graphics are applied, may be stretched over the frame.

18. The interactive tradeshow display system of claim 14 wherein the at least one networked 3D holographic image generator is a persistence of vision display consisting of a fan with a plurality of networked LED lights which employs the persistence of vision effect to display an image such that human eyes imagine the said image as an independent, floating image.

19. The interactive tradeshow display system of claim 14 wherein the at least one networked 3D holographic image generator may be mounted to the at least one frame.

20. The interactive tradeshow display system of claim 14 wherein the at least one networked electronic video display is a networked sewable or wearable LED display which may be attached to the cover component of the said interactive tradeshow display system.
